(19) United States
(12) Patent Application Publication
(10) Pub. No.: US 2024/0120951 A1
(43) Pub. Date: Apr. 11, 2024

(54) WIFI RF FRONT END AND ANTENNA MULTIPLEXING

(71) Applicant: Cisco Technology, Inc., San Jose, CA (US)

(72) Inventor: Fred J. ANDERSON, Lakeville, OH (US)

(21) Appl. No.: 17/938,266

(22) Filed: Oct. 5, 2022

(51) Int. Cl. H04B 1/00; H04B 1/04

(52) U.S. Cl. CPC H04B 1/0057; H04B 1/04; H04B 2001/0408

(57) ABSTRACT

Techniques for wireless antenna multiplexing are disclosed. An antenna system for wireless communication includes a plurality of diplexers and first and second antenna arrays. The first antenna array is coupled to a first radio-frequency integrated circuit (RFIC) configured to operate at a first frequency band including a first plurality of sub-bands, and a second RFIC configured to operate at a second frequency band including a second plurality of sub-bands. The second antenna array is coupled to both the first RFIC and the second RFIC. Adjacent portions of the first plurality of sub-bands and the second plurality of sub-bands are assigned to different antenna arrays of the first and second antenna arrays using the plurality of diplexers.

### TECHNICAL FIELD

Embodiments presented in this disclosure generally relate to wireless communication. More specifically, embodiments disclosed herein relate to wireless antenna multiplexing.

### BACKGROUND

Modern wireless access points (APs) commonly employ multiple serving radios that operate simultaneously. For example, an AP may include a 2.4 GHz radio and a 5 GHz radio. But APs with multiple simultaneously operated radios face serious coexistence problems. This can be even more challenging when the APs operate in continuous band segments of Unlicensed National Information Infrastructure (U-NII) 1-8 (i.e., U-NII-1-U-NII-8). Existing solutions employ separate antenna arrays for each radio, plus highly selective switchable post-front-end module (FEM) band-pass filters which incur substantial losses. This approach has many downsides, including requiring a large number of antenna arrays, and leading to RF output power dissipation through those losses. This results in poor power and thermal efficiency, poor reception (RX) and transmission (TX) performance, and significantly increased costs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates antenna coexistence for a multi-radio AP using separate antennas, according to one embodiment.

FIG. 1B illustrates antenna coexistence for a multi-radio AP using a diplexer, according to one embodiment.

FIG. 1C illustrates antenna coexistence for a multi-radio AP using separate antennas and a diplexer, according to one embodiment.

FIG. 2 illustrates an architecture for RF front end and antenna multiplexing, according to one embodiment.

FIG. 3 illustrates a further architecture for RF front end and antenna multiplexing, according to one embodiment.

FIG. 4 illustrates pre-FEM filtering results using an architecture for RF front end and antenna multiplexing, according to one embodiment.

FIG. 5 illustrates a reduction in unwanted emissions using an architecture for RF front end and antenna multiplexing, according to one embodiment.

FIG. 6 illustrates a dipole architecture for use in RF front end and antenna multiplexing, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments include a wireless access point (AP), including a first antenna array, a second antenna array, a plurality of diplexers, a first radio-frequency integrated circuit (RFIC) configured to operate at a first frequency band including a first plurality of sub-bands, and a second RFIC configured to operate at a second frequency band including a second plurality of sub-bands. The first RFIC and the second RFIC are both coupled to the first antenna array and the second antenna array. Adjacent portions of the first plurality of sub-bands and the second plurality of sub-bands are assigned to different antenna arrays of the first and second antenna arrays using the plurality of diplexers.

Embodiments further include an antenna system for wireless communication, including: a plurality of diplexers and a first antenna array coupled to a first radio-frequency integrated circuit (RFIC) configured to operate at a first frequency band including a first plurality of sub-bands, and a second RFIC configured to operate at a second frequency band including a second plurality of sub-bands. The antenna system further includes a second antenna array coupled to both the first RFIC and the second RFIC. Adjacent portions of the first plurality of sub-bands and the second plurality of sub-bands are assigned to different antenna arrays of the first and second antenna arrays using the plurality of diplexers.

Embodiments further include a method. The method includes transmitting and receiving data at a wireless access point (AP) using a first radio-frequency integrated circuit (RFIC) configured to operate at a first frequency band including a first plurality of sub-bands. The method further includes transmitting and receiving data at the AP using a second RFIC configured to operate at a second frequency band comprising a second plurality of sub-bands. The first RFIC and the second RFIC are both coupled to a first antenna array and a second antenna array. Adjacent portions of the first plurality of sub-bands and the second plurality of sub-bands are assigned to different antenna arrays of the first and second antenna arrays using a plurality of diplexers.

### Example Embodiments

As discussed above, employing multiple serving radios that operate simultaneously in an AP is challenging. This is even more challenging as APs begin to use 6 GHz radios simultaneously with adjacent 5 GHz radios, which can create significant coexistence challenges. One or more techniques disclosed herein relate to an improved RF front-end architecture that reduces antenna array requirements by multi-radio mapping (e.g., for 6 GHz radios, 5 GHz radios, 2.4 GHz radios, or any other suitable band) and significantly reduces, or effectively eliminates, typical post-FEM filtering losses with diplexing techniques.

In an embodiment, this is achieved through a combination of any of multiple techniques. For example, an improved architecture can use sub band pre-filtering to reduce thermal noise before power amplification, thereby relaxing the post-filtering requirements (and resulting insertion loss). This can be done using relatively inexpensive pre-FEM band-pass filtering after a radio-frequency integrated circuit (RFIC). This is a significant improvement over existing techniques that use switchable post-FEM band pass filters.

Further, an improved architecture can exploit frequency sub band selectivity available in 5/6 GHz diplexers using bulk acoustic wave (BAW) or surface acoustic wave (SAW) resonators, and can cross couple multiple diplexed signals to multiple antenna arrays to leverage the array isolation for adjacent sub band coexistence. For example, radio sub band operation can be mapped across multiple antenna arrays taking into account coexistence. In this example, low 5 GHz sub-bands can be mapped with low 6 GHz sub-bands, and high 5 GHz sub-bands can be mapped with high 6 GHz sub-bands, so that adjacent sub bands are mapped to opposite physical antenna arrays. In an embodiment, antenna arrays can be designed for enhanced isolation (e.g., approximately 40 dB isolation) to achieve adjacent sub band coexistence.

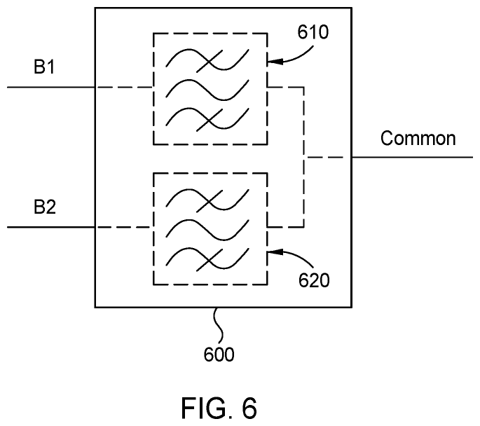

Finally, an improved architecture can use backoff of power amplifiers (PAs) from their saturated power output (Psat) levels to target off-channel intermodulation (IM) product levels compatible with the overall sub-band isolation of the antenna system. That is, the improved architecture can operate FEM PAs at relatively low levels compared to prior solutions (e.g., 10 dB below Psat). This can achieve lower IM products (e.g., reducing distortion) and reduce post-FEM filtering requirements. In this example, as illustrated below in relation to FIG. 6, post-FEM filtering can be done using low-loss bulk acoustic wave (BAW) based diplexers.

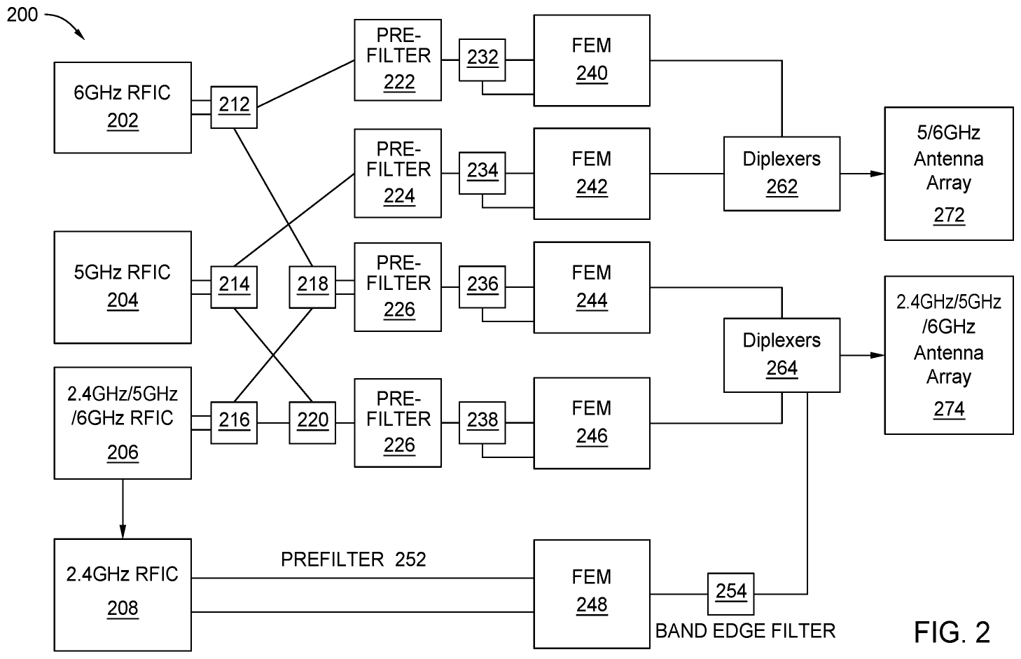

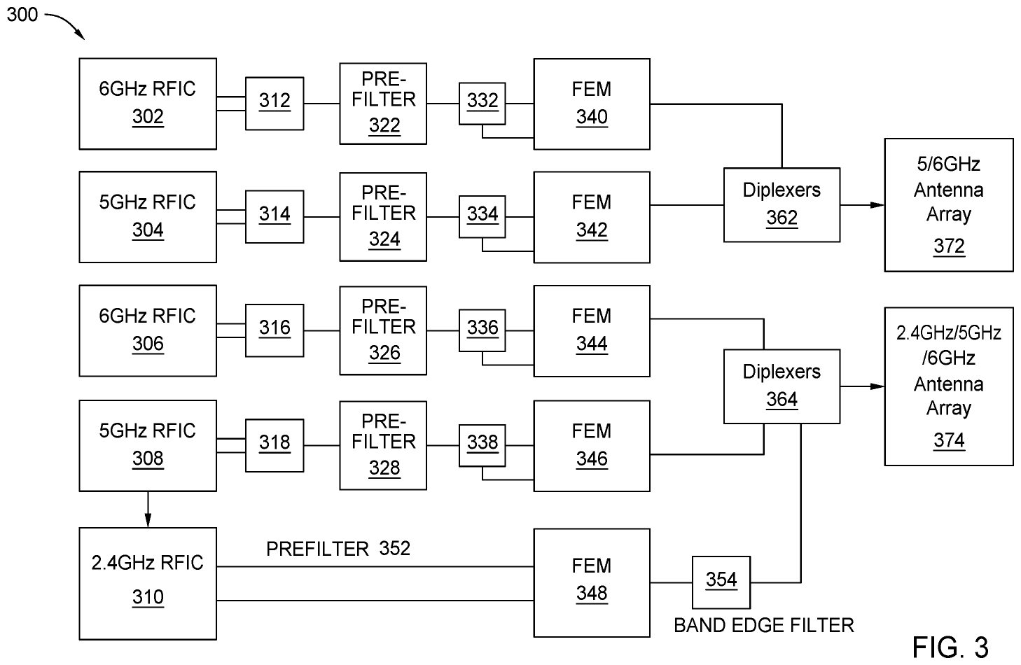

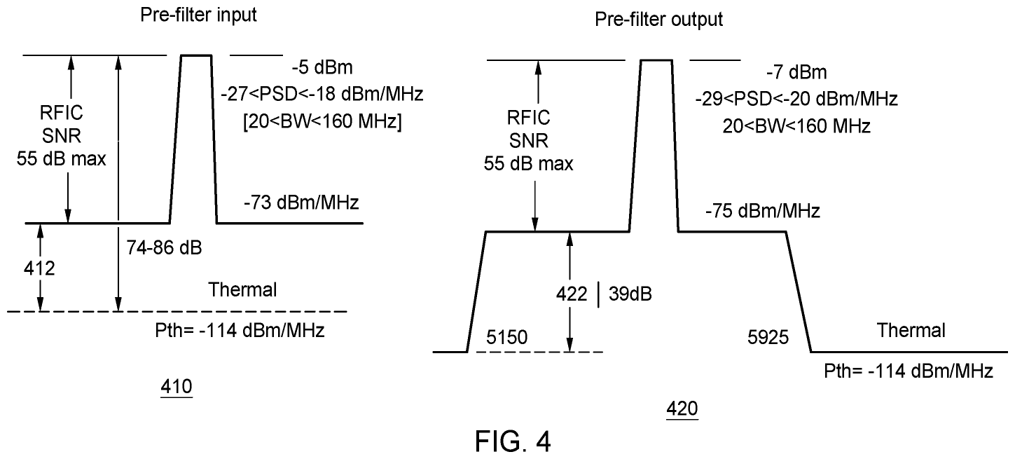

In an embodiment, using a combination of these multiple techniques can result in sufficient level of antenna isolation (e.g., 70-80 dB of antenna isolation) to operate multiple simultaneous radios with shared antenna arrays. For example, pre-FEM band-pass filtering (e.g., as discussed further below with regard to FIG. 4) can provide partial isolation, physical antenna isolation (e.g., as discussed below with regard to FIGS. 2-3) can provide additional isolation, and the use of BAW diplexers (e.g., as discussed below with regard to FIG. 6) can provide sufficient isolation for multiple simultaneous radio operation using shared antenna arrays.

Using one or more of these techniques can provide significant advantages. For example, it can allow for full utilization of 5 GHz and 6 GHz antenna arrays (e.g., with two radios mapped to each array), rather than requiring an antenna array for each radio. This results in a doubling of space and cost efficiency, and enables more capacity per AP. This can be particularly important in high density venues (e.g., arenas, stadiums, and the like).

As another example, one or more of the techniques disclosed herein can provide a significant reduction of post-FEM losses (e.g., a 4-5 dB reduction in losses). This can lead to improved linearity and improved modulation coding scheme (MCS) data rates, or to power savings (e.g., depending on design preferences). Further, one or more of the techniques disclosed herein can provide multi-radio scaling, with limited or no self-interference and no macro-cell/micro-cell radio range limitations, and improved receiver performance commensurate with reduced post-FEM losses.

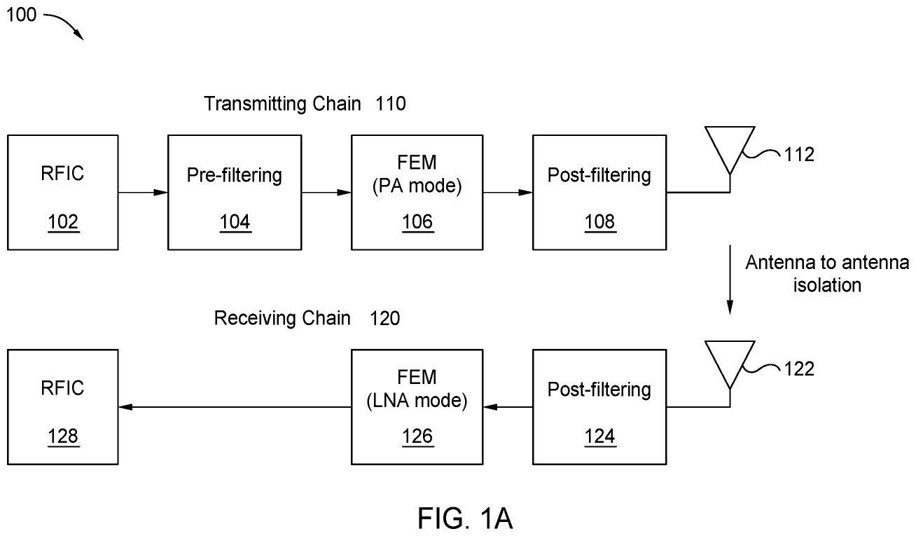

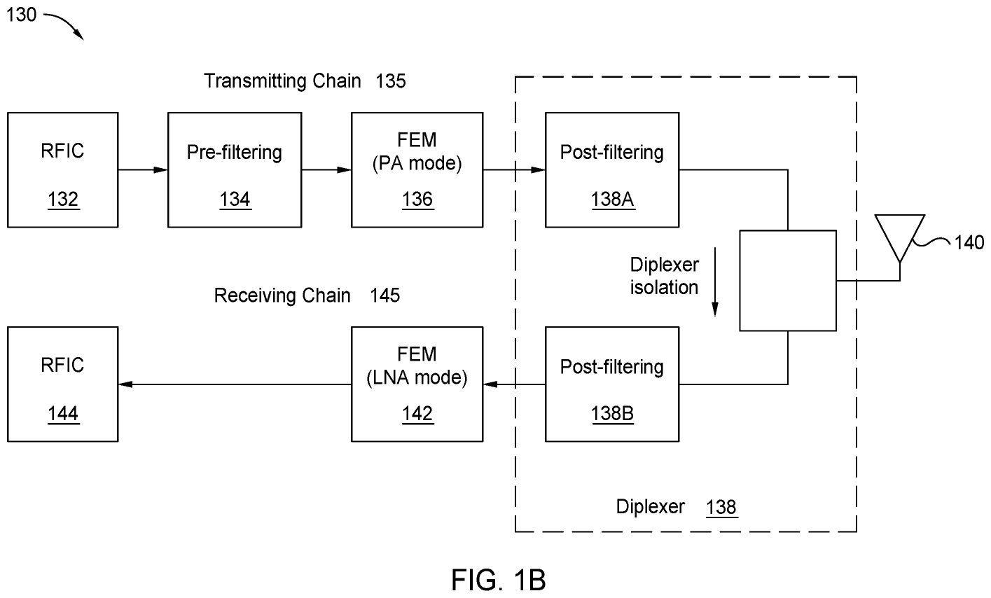

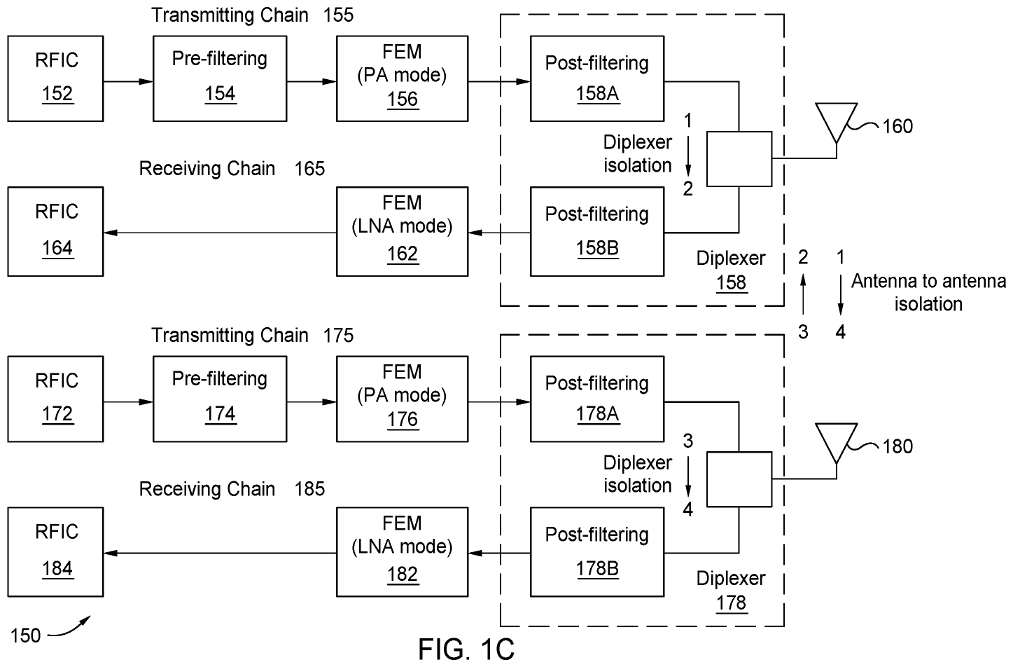

FIG. 1A illustrates an architecture 100 for antenna coexistence for a multi-radio AP using separate antennas, according to one embodiment. In an embodiment, the architecture 100 illustrates a general model of the interaction of transmitter sections of one co-located radio with the receiver section of another. The architecture 100 assumes non-coordinated carrier-sense multiple access (CSMA) protocols (e.g., for WiFi).

In an embodiment, the architecture 100 includes a transmitting chain 110 with an RFIC 102, pre-filtering 104, a FEM 106 (e.g., operating in power amplifier (PA) mode), post-filtering 108, and an antenna 112 (e.g., an antenna array). As illustrated, pre-filtering and post-filtering are relative to the power amplification in the transmitting chain 110 (e.g., the pre-filtering 104 occurs before power amplification in the FEM, and the post-filtering 108 occurs after the power amplification in the FEM). The architecture 100 further includes a receiving chain 120, including an antenna 122 (e.g., an antenna array), post-filtering 124, a FEM 126 (e.g., operating in low-noise amplifier (LNA) mode), and an RFIC 128.

In an embodiment, transmitting chain 110 and the receiving chain 120 are co-located (e.g., in an AP). That is, the receiving chain 120 is not the desired destination for the transmitting chain 110. Instead, the transmitting chain 110 and receiving chain 120 relate to separate RFICs 102 and 128, and should be isolated. In an embodiment, the dominant interference mechanism between the transmitting chain 110 and the receiving chain 120 is unwanted emissions from the transmitting chain 110 infiltrating the receiving chain 120 due to coupling between the antennas 112 and 122. As illustrated, this is reduced by providing separate antennas 112 and 122 for the transmitting chain 110 and the receiving chain 120 and isolating the antennas 112 and 122.

FIG. 1B illustrates an architecture 130 for antenna coexistence for a multi-radio AP using a diplexer, according to one embodiment. In an embodiment, the architecture 130 uses a shared antenna 140 (e.g., an antenna array). The architecture 130 uses this shared antenna 140 (e.g., instead of separate antennas 112 and 122 used in the architecture 100 illustrated in FIG. 1A), by including a diplexer 138. The architecture 130 includes a transmitting chain 135 with an RFIC 132, pre-filtering 134, and an FEM 136 (e.g., operating in PA mode), and a receiving chain 145 with an FEM 142 (e.g., operating in LNA mode) and an RFIC 144.

In an embodiment, the receiving chain 145 is again not the desired destination for the transmitting chain 135. Instead, the transmitting chain 135 and receiving chain 145 relate to separate RFICs 132 and 144, and should be isolated. In the architecture 130, this is achieved using a shared antenna 140 and a diplexer 138 that includes post-filtering 138A in the transmitting chain 135 and post-filtering 138B in the receiving chain 145. By using antenna sharing with the diplexer 138, the dominant interference mechanism between the transmitting chain 135 and the receiving chain 145 is now the conducted isolation characteristics of the diplexer 138.

FIG. 1C illustrates an architecture 150 for antenna coexistence for a multi-radio AP using separate antennas and a diplexer, according to one embodiment. In an embodiment, the architecture 150 supports four RFICs 152, 164, 172, and 184, and multiple transmitting chains 155 and 175 and receiving chains 165 and 185. The architecture 150 both isolates transmitting and receiving chains with shared antennas using diplexers (e.g., as illustrated above in the architecture 130 illustrated in FIG. 1B), and isolates between separate antennas (e.g., as illustrated above in the architecture 100 illustrated in FIG. 1A).

The architecture 150 includes a transmitting chain 155 with an RFIC 152, pre-filtering 154, and an FEM 156 (e.g., operating in PA mode), and a receiving chain 165 with an FEM 162 (e.g., operating in LNA mode) and an RFIC 164. The transmitting chain 155 and the receiving chain 165 share an antenna 160 (e.g., an antenna array) using a diplexer 158, which includes post-filtering 158A in the transmitting chain 155 and post-filtering 158B in the receiving chain 165.

The architecture 150 further includes another transmitting chain 175 with an RFIC 172, pre-filtering 174, and an FEM 176 (e.g., operating in PA mode), and another receiving chain 185 with an FEM 182 (e.g., operating in LNA mode) and an RFIC 184. The transmitting chain 175 and the receiving chain 185 share an antenna 180 (e.g., an antenna array) using a diplexer 178, which includes post-filtering 178A in the transmitting chain 175 and post-filtering 178B in the receiving chain 185.

As illustrated, the architecture 150 includes two antennas 160 and 180, and four RFICs 152, 164, 172, and 184. When multiple antennas (e.g., multiple antenna arrays) are added to support more than two radios, the interference mechanisms are two fold, and bi-directional across the antenna to antenna coupling. Thus, the architecture 150 includes both isolation within the shared antennas 160 and 180 using the respective diplexers 158 and 178, and isolation between the antennas 160 and 180. For example, the transmitting chain 155 is isolated from the receiving chain 165 using the diplexer 158, and from the receiving chain 185 using the separate antennas 160 and 180. Similarly, the transmitting chain 175 is isolated from the receiving chain 185 using the diplexer 178, and from the receiving chain 165 using the separate antennas 160 and 180.

FIG. 2 illustrates an architecture 200 for RF front end and antenna multiplexing, according to one embodiment. In an embodiment, the architecture 200 includes four simultaneous radios: RFICs 202, 204, 206, and 208. For example, the RFIC 202 can be a 6 GHz RFIC, the RFIC 204 can be a 5 GHz RFIC, the RFIC 206 can be an RFIC that operates at any of 2.4 GHz, 5 GHz, or 6 GHz, and the RFIC 208 can be a 2.4 GHz RFIC. These are merely examples, and the RFICs 202, 204, 206, and 208 can operate at any suitable frequency band or combinations of bands. Further, the use of four simultaneous radios is also merely an example, and the architecture 200 can be applied to any suitable number of simultaneous radios (e.g., three simultaneous radios or five simultaneous radios as illustrated further in FIG. 3).

In an embodiment, the architecture 200 supports output from any of the four RFICs 202, 204, 206, and 208. For example, the architecture 200 can include a number of switches (e.g., double pole double throw (DPDT) switches, single pole double throw (SPDT) switches, or any other suitable switches) 212, 214, 216, 218, 220, 232, 234, 236, and 238 to facilitate providing output from any of the four RFICs 202, 204, 206, and 208. For example, the switches 212, 214, and 216 can be DPDT switches. In this example, the switches 218, 220, 232, 234, 236, and 238 can be SPDT switches. This is merely an example, and any suitable type and number of switches can be used.

In an embodiment, the architecture 200 includes pre-filters 222, 224, 226, and 228 before the respective FEMs 240, 242, 244, 246, and 248. For example, the pre-filters 222, 224, 226, and 228 can be band-pass filters between the respective RFIC outputs and FEM inputs. In an embodiment, as discussed further below with regard to FIG. 4, including pre-FEM band-pass filters reduces the noise floor of the out-of-sub-band signals from the RFIC to the thermal noise floor, and can reduce (or eliminate) the need for post-FEM filtering. This is a significant improvement over existing techniques that use switchable post-FEM band pass filters. Further, the RFIC 208 can include pre-filtering 252 before the FEM 248, and a band edge filter 254 after the FEM 248. In an embodiment, the 2.4 GHz subsystems (e.g., the 2.4 GHz RFIC 208, FEM 248, and band edge filter 254 illustrated in FIG. 2 and the 2.4 GHz RFIC 310, FEM 348, and band edge filter 354 illustrated in FIG. 3) are treated differently from the 5 and 6 GHz subsystems due to their lack of interaction and interference with the 5 and 6 GHz subsystems (e.g., due to the large frequency separation). In the case of the 2.4 GHz subsystems, coexistence requirements may be more easily met with conventional filtering and diplexing approaches.

While the architecture 200 includes four FEMs 240, 242, 244, and 246, as illustrated, this is merely an example. The architecture 200 can instead include three FEMs, or any other suitable number of FEMs.

Further, in an embodiment, the architecture 200 includes two antenna arrays 272 and 274. These antenna arrays 272 and 274 can be shared among the four RFICs 202, 204, 206, and 208 using multiple diplexers 262 and 264. The diplexers 262 and 264 are described further, below, with regard to FIG. 6A. Further, in an embodiment, the diplexers 262 and 264 can each include multiple diplexing components. For example, the diplexer 264 can include multiple diplexing components to support three inputs, from all of the FEMs 244, 246, and 248, to the antenna array 274. Further, the diplexers 262 and 264 can include very low loss post-FEM filtering, as discussed below in relation to FIG. 6A.

In an embodiment, the architecture 200 can segregate the 5 and 6 GHz bands into multiple sub-bands (e.g., four sub-bands) for simultaneous operation. For example, low 5 GHz sub-bands (e.g., from the 5 GHz RFIC 204) can be mapped with low 6 GHz sub-bands (e.g., from the 6 GHz RFIC 202), and high 5 GHz sub-bands can be mapped with high 6 GHz sub-bands, so that adjacent sub bands are mapped to opposite physical antenna arrays (e.g., to the antenna arrays 272 and 274).

As illustrated, the architecture 200 supports output from four RFICs 202, 204, 206, and 208, using two shared antenna arrays 272 and 274, while isolating (e.g., at least partially isolating) the receiving chain of any given radio in the architecture 200 from the transmitting chains of other radios in the architecture 200. As discussed further below with regard to FIGS. 4-6B, this reduces the noise floor of the out-of-subband signals from the RFIC to thermal noise floor, minimizes unwanted emissions, and limits post-FEM filtering losses.

FIG. 3 illustrates a further architecture 300 for RF front end and antenna multiplexing, according to one embodiment. In an embodiment, the architecture 300 includes five simultaneous radios: RFICs 302, 304, 306, 308, and 310. For example, the RFIC 3 can be a 6 GHz RFIC, the RFIC 304 can be a 5 GHz RFIC, the RFIC 306 can be a 6 GHz RFIC, the RFIC 308 can be a 5 GHz RFIC, and the RFIC 310 can be a 2.4 GHz RFIC. These are merely examples, and the RFICs 302, 304, 306, 308, and 310 can operate at any suitable frequency band or combinations of bands. Further, the use of five simultaneous radios is also merely an example, and the architecture 300 can be applied to any suitable number of simultaneous radios (e.g., three simultaneous radios or four simultaneous radios as illustrated further in FIG. 2, above).

In an embodiment, the architecture 300 supports output from any of the five RFICs 302, 304, 306, 308, and 310. For example, the architecture 300 can include a number of switches (e.g., DPDT switches, SPDT switches, or any other suitable switches) 312, 314, 316, 318, 332, 334, 336, and 338 to facilitate providing output from any of the five RFICs 302, 304, 306, 308, and 310. For example, the switches 312, 314, 316, and 318 can be DPDT switches. In this example, the switches 332, 334, 336, and 338 can be SPDT switches. This is merely an example, and any suitable type and number of switches can be used.

In an embodiment, the architecture 300 includes pre-filters 322, 324, 326, and 328 before the respective FEMs 340, 342, 344, 346, and 348. For example, the pre-filters 322, 324, 326, and 328 can be band-pass filters between the respective RFIC outputs and FEM inputs. In an embodiment, as discussed further below with regard to FIG. 4, including pre-FEM band-pass filters reduces the noise floor of the out-of-sub-band signals from the RFIC to the thermal noise floor, and can reduce (or eliminate) the need for post-FEM filtering. This is a significant improvement over existing techniques that use switchable post-FEM band pass filters. Further, the RFIC 310 can include pre-filtering 352 before the FEM 348, and a band edge filter 354 after the FEM 348. As discussed above in relation to the 2.4 GHz RFIC 208 illustrated in FIG. 2, in an embodiment the 2.4 GHz subsystems are treated differently from the 5 and 6 GHz subsystems due to their lack of interaction and interference with the 5 and 6 GHz subsystems.

Further, in an embodiment, the architecture 300 includes two antenna arrays 372 and 374. These antenna arrays 372 and 374 can be shared among the five RFICs 302, 304, 306, 308, and 310 using multiple diplexers 362 and 364. The diplexers 362 and 364 are described further, below, with regard to FIG. 6A. Further, in an embodiment, the diplexers 362 and 364 can each include multiple diplexing components. For example, the diplexer 364 can include multiple diplexing components to support three inputs, from all of the FEMs 344, 346, and 348, to the antenna array 374. Further, the diplexers 362 and 364 can include very low loss post-FEM filtering, as discussed below in relation to FIG. 6A.

In an embodiment, the architecture 300 can segregate the 5 and 6 GHz bands into multiple sub-bands (e.g., four sub-bands) for simultaneous operation. For example, low 5 GHz sub-bands can be mapped with low 6 GHz sub-bands, and high 5 GHz sub-bands can be mapped with high 6 GHz sub-bands, so that adjacent sub bands are mapped to opposite physical antenna arrays (e.g., to the antenna arrays 372 and 374).

As illustrated, the architecture 300 supports output from five RFICs 302, 304, 306, 308, and 310, using two shared antenna arrays 372 and 374, while isolating (e.g., at least partially isolating) the receiving chain of any given radio in the architecture 300 from the transmitting chains of other radios in the architecture 300. As discussed further below with regard to FIGS. 4-6B, this reduces the noise floor of the out-of-subband signals from the RFIC to thermal noise floor, minimizes unwanted emissions, and limits post-FEM filtering losses.

FIG. 4 illustrates pre-FEM filtering results using an architecture for RF front end and antenna multiplexing, according to one embodiment. In an embodiment, FIG. 4 illustrates providing 40 dB of stopband filtering between an RFIC and FEM (e.g., as illustrated above in relation to FIGS. 2-3). A pre-filtering input is shown in a graph 410, and a pre-filtering output is shown in a graph 420. The pre-filtering significantly reduces the noise floor of the out-of-subband signals from the RFIC to the thermal noise floor.

As illustrated, an example RFIC has a 55 dB maximum signal to noise ratio (SNR). Prior to the filtering, the distance between the bottom of the RFIC SNR and the thermal noise floor, labeled as 412, is 20-30 dB. The filtering significantly decreases thermal noise, so that after filtering the distance between the bottom of the RFIC SNR and the thermal noise floor, labeled as 422, has increased to 39 dB.

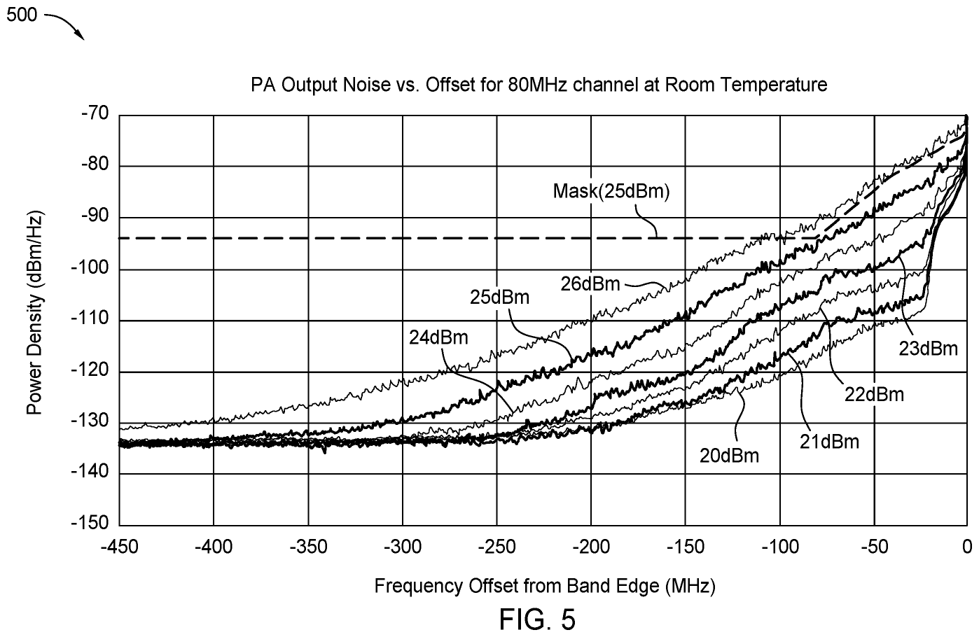

FIG. 5 illustrates a reduction in unwanted emissions using an architecture for RF front end and antenna multiplexing, according to one embodiment. In an embodiment, a graph 500 illustrates a PA with 80 MHz channels. As illustrated, an increase in output power (represented along the y-axis) increases unwanted out of band emissions.

As discussed above, using one or more techniques disclosed herein (e.g., as illustrated in FIGS. 2-3) allows for a significant reduction in power amplification. The graph 500 illustrates the significant, non-linear, decrease in unwanted emissions that accompanies operating at a lower power amplification. Using lessened power amplification (e.g., in FEMs) results in significantly lessened unwanted emissions from the FEMs. This reduces the need for post-FEM filtering, because unwanted emissions are reduced due to the lessened power amplification at the FEM and need not be filtered out.

FIG. 6 illustrates a dipole architecture for use in RF front end and antenna multiplexing, according to one embodiment. A dipole 600 and includes two BAW band-pass filters 610 and 620 with corresponding inputs B1 and B2, and a common output. In an embodiment, the dipole 600 can be used in any of the architectures illustrated in FIGS. 1B, 1C, 2, and 3. While the dipole 600 is illustrated as using BAW band-pass filters, this is merely an example. Any suitable technology can be used (e.g., SAW band-pass filters or any other suitable technology).

Modern BAW technology has enabled diplexer designs with very low insertion loss (1-1.5 dB) with reasonable B1-B2 isolation (e.g. 40 dB). Using these diplexers instead of switchable post FEM band pass filters (e.g., as used in existing systems) can save 2.5-3 dB of insertion loss, and enables a significant improvement to the error vector magnitude (EVM) operating point for the PA.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless access point (AP), comprising:
a first antenna array;
a second antenna array;
a plurality of diplexers;
a first radio-frequency integrated circuit (RFIC) configured to operate at a first frequency band comprising a first plurality of sub-bands; and
a second RFIC configured to operate at a second frequency band comprising a second plurality of sub-bands,
wherein the first RFIC and the second RFIC are both coupled to the first antenna array and the second antenna array, and
wherein adjacent portions of the first plurality of sub-bands and the second plurality of sub-bands are assigned to different antenna arrays of the first and second antenna arrays using the plurality of diplexers.

2. The wireless AP of claim 1, wherein the first frequency band comprises a 5 GHz band and the second frequency band comprises a 6 GHz frequency band.

3. The wireless AP of claim 2, wherein the adjacent portions of the first plurality of sub-bands and the second plurality of sub-bands comprise a highest sub-band for the 5 GHz band and a lowest sub-band for the 6 GHz frequency band.

4. The wireless AP of claim 1, further comprising:
a first filter coupled between the first RFIC and a first front-end-module (FEM) providing power amplification; and
a second filter coupled between the second RFIC and a second FEM providing power amplification.

5. The wireless AP of claim 4, wherein the first filter and the second filter each comprise band-pass filters.

6. The wireless AP of claim 5, wherein the first FEM and the second FEM are each configured to amplify power below a saturated output power (Psat) level.

7. The wireless AP of claim 6, wherein the first FEM and the second FEM are each configured to amplify power approximately 10 dB below the Psat level.

8. The wireless AP of claim 1, further comprising a third RFIC and a fourth RFIC, wherein the third RFIC and the fourth RFIC are both configured to use at least one of the first and second antenna arrays.

9. The wireless AP of claim 8, further comprising:
four FEMs, each of the FEMs coupled to at least one of the RFICs and providing power amplification for the respective at least one of the RFICs.

10. The wireless AP of claim 1, wherein the plurality of diplexers each comprise a plurality of bulk acoustic wave (BAW) band-pass filters.

11. An antenna system for wireless communication, comprising:
a plurality of diplexers;
a first antenna array coupled to:
a first radio-frequency integrated circuit (RFIC) configured to operate at a first frequency band comprising a first plurality of sub-bands, and
a second RFIC configured to operate at a second frequency band comprising a second plurality of sub-bands; and
a second antenna array coupled to both the first RFIC and the second RFIC,
wherein adjacent portions of the first plurality of sub-bands and the second plurality of sub-bands are assigned to different antenna arrays of the first and second antenna arrays using the plurality of diplexers.

12. The antenna system of claim 11,
wherein the first frequency band comprises a 5 GHz band and the second frequency band comprises a 6 GHz frequency band, and
wherein the adjacent portions of the first plurality of sub-bands and the second plurality of sub-bands comprise a highest sub-band for the 5 GHz band and a lowest sub-band for the 6 GHz frequency band.

13. The antenna system of claim 11, further comprising:
a first filter coupled between the first RFIC and a first front-end-module (FEM) providing power amplification; and
a second filter coupled between the second RFIC and a second FEM providing power amplification.

14. The antenna system of claim 13,
wherein the first filter and the second filter each comprise band-pass filters, and
wherein the first FEM and the second FEM are each configured to amplify power below a saturated output power (Psat) level.

15. A method, comprising:
transmitting and receiving data at a wireless access point (AP) using a first radio-frequency integrated circuit (RFIC) configured to operate at a first frequency band comprising a first plurality of sub-bands; and
transmitting and receiving data at the AP using a second RFIC configured to operate at a second frequency band comprising a second plurality of sub-bands,
wherein the first RFIC and the second RFIC are both coupled to a first antenna array and a second antenna array, and
wherein adjacent portions of the first plurality of sub-bands and the second plurality of sub-bands are assigned to different antenna arrays of the first and second antenna arrays using a plurality of diplexers.

16. The method of claim 15,
wherein the first frequency band comprises a 5 GHz band and the second frequency band comprises a 6 GHz frequency band, and
wherein the adjacent portions of the first plurality of sub-bands and the second plurality of sub-bands comprise a highest sub-band for the 5 GHz band and a lowest sub-band for the 6 GHz frequency band.

17. The method of claim 15, wherein the AP further comprises:
a first filter coupled between the first RFIC and a first front-end-module (FEM) providing power amplification; and
a second filter coupled between the second RFIC and a second FEM providing power amplification.

18. The method of claim 17, wherein the first FEM and the second FEM are each configured to amplify power below a saturated output power (Psat) level.

19. The method of claim 15, further comprising:
transmitting and receiving data at the AP using a third RFIC coupled to at least one of the first antenna array or the second antenna array; and
transmitting and receiving data at the AP using a fourth RFIC coupled to at least one of the first antenna array or the second antenna array.

20. The method of claim 19, wherein each of the respective first RFIC, second RFIC, third RFIC, and fourth RFIC is coupled to at least one of four FEMs providing power amplification.
